(19) United States
(12) Patent Application Publication
(10) Pub. No.: US 2026/0127394 A1
(43) Pub. Date: May 7, 2026

(54) DYNAMICALLY CUSTOMIZING A USER INTERFACE OF AN ELECTRONIC PLATFORM VIA MACHINE LEARNING

(71) Applicant: PAYPAL, INC., San Jose, CA (US)

(72) Inventor: Xiaoying Han, San Jose, CA (US)

(21) Appl. No.: 18/939,023

(22) Filed: Nov. 6, 2024

(51) Int. Cl. G06F 40/58; H04L 51/02

(52) U.S. Cl. CPC G06F 40/58; H04L 51/02

(57) ABSTRACT

Via one or more electronic communication channels of an electronic platform, a request is detected from a user to interact with the electronic platform. Via a Natural Language Processing (NLP) model, an intent of the user behind the request to interact with the electronic platform is predicted. Via an Explainable Artificial Intelligence (XAI) model, one or more features associated with the user that contributed to the predicted intent are determined. Via a Large Language Model (LLM), a personalized message is generated for the user. The personalize message refers to the intent predicted by the NLP model or the one or more features associated with the user determined by the XAI model that contributed to the predicted intent. The personalized message is provided to the user via the one or more electronic communication channels.

### BACKGROUND

### Field of the Invention

The present application generally relates to machine learning. More particularly, the present application involves using Natural Language Processing (NLP), Explainable Artificial Intelligence (XAI), and Large Language Models (LLMs) to generate a dynamically changing user interface of an electronic platform.

### Related Art

Over the past several decades, rapid advances in Integrated Circuit fabrication and wired/wireless telecommunications technologies have brought about the arrival of the information age, in which electronic communications or interactions between various entities are becoming increasingly more common. For example, a user may interact with an entity (e.g., an electronic platform) through a user interface of the electronic platform in various situations. Unfortunately, conventional methods and systems have not been able to address the changing needs of the users, which may be different from user to user, and/or may change from time to time even for the same user. For example, an electronic platform may provide a static user interface that displays generic answers and/or prompts, which may not adequately address the user's questions and/or concerns and may therefore leave the user frustrated. This may also result in the user engaging more with the electronic platform in an attempt to get the desired content, which may then lead to additional time and computer processing by both the user device and the electronic platform. What is needed is a user interface that can be dynamically updated for a specific user based on information associated with that user, such that the user's needs can be anticipated and accurately addressed.

### BRIEF DESCRIPTION OF THE FIGURES

FIG. 1 is a block diagram of a networked system according to various aspects of the present disclosure.

FIGS. 2-4 illustrate a simplified process flows for providing a personalized experience to a user according to embodiments of the present disclosure.

FIGS. 5A-5F illustrate example user interfaces for providing a personalized experience to a user according to various aspects of the present disclosure.

FIG. 6 illustrates an example artificial neural network according to various aspects of the present disclosure.

FIG. 7 is a simplified example of a cloud-based computing architecture according to various aspects of the present disclosure.

FIGS. 8-9 are flowcharts illustrating methods of providing a personalized experience to a user according to various aspects of the present disclosure.

FIG. 10 illustrates a computer system according to various aspects of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity.

The present disclosure pertains to using machine learning models, such as Natural Language Processing (NLP), Explainable Artificial Intelligence (XAI), and Large Language Models (LLMs), to generate a dynamically changing user interface of an electronic platform. Conventionally, a user may interact with an electronic platform via one or more communication channels, for example, via a webpage, an online chat, a telephone call, an email, etc. Often times, the user is engaging in such an interaction because the user needs to have one or more issues resolved (e.g., getting a refund, changing a password, submitting a dispute, etc.).

However, existing systems and methods have not been able to provide a personalized experience for the user. Instead, existing systems and methods typically provide a generic and/or static experience for their users. For example, an electronic platform may have a Frequently Asked Questions (FAQ) page that does not change from user to user, and it typically contains a static (e.g., unchanging) list of questions and answers that may or may not apply to all the users as a whole. Unfortunately, such a list may not be particularly relevant to any given user, who may have a specific issue in mind, but that issue is not included in the FAQ. As another example, electronic platforms may deploy computer chatbots to chat with users. However, such chatbots often greet the users with generic messages, and the ensuing messages (after the greeting) may also not be targeted to any particular user's specific problems. Such a one-size-fits-all approach my lead to user frustration, confusion, and/or dissatisfaction with the electronic platform, as well as use of additional computing resources and time.

In contrast, the present disclosure involves using machine learning processes to generate personalized experiences for users of an electronic platform. For example, a user (e.g., a customer) of an electronic platform may initiate an interaction with the electronic platform via one or more communication channels (e.g., an online Help Center webpage, an Interactive Voice Response (IVR) system, or a computer chatbot). The present disclosure utilizes one or more machine learning models, such as NLP, XAI, and LLM, to predict the underlying intent of the user in contacting the electronic platform. Once the predicted user intent is determined, one or more of the machine learning models are also used to generate a personalized experience for the user. For example, the personalized experience may include a personalized Help Center webpage with questions and answers specifically addressing the user's intent, or an IVR system voice menu containing options that are customized to the user's intent, or a computer chatbot that greets the user with a personalized message (e.g., a message referencing a past activity of the user and asking if that is why the user is contacting the electronic platform). The user may provide a response via one or more of the communication channels, and based on the user response, the personalized experience may be updated and communicated back to the user via one or more of the communication channels.

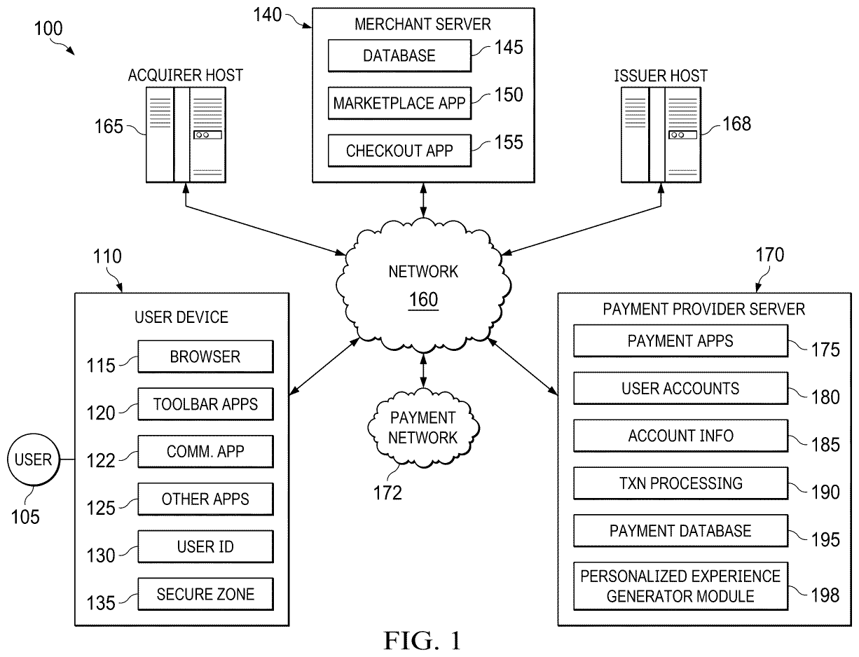

In this manner, the platform may leverage the capabilities of machine learning and the user's past activities on an electronic platform to turn potentially negative outcomes (e.g., the user leaving the platform due to dissatisfaction with a cumbersome and confusing interaction with the platform or engaging in additional interactions with the platform to get to the desired content) into positive ones (e.g., an increase in the satisfaction of the user with the platform due to the user's underlying concern being addressed automatically in a personalized manner quickly). The various aspects of the present disclosure are discussed in more detail below with reference to FIGS. 1-9.

FIG. 1 is a block diagram of a networked system 100 or architecture suitable for conducting electronic online transactions according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT™ OS, a UNIX™ OS, a LINUX™ OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

The system 100 may include a user device 110, a merchant server 140, a payment provider server 170, an acquirer host 165, an issuer host 168, and a payment network 172 that are in communication with one another over a network 160. Payment provider server 170 may be maintained by a payment service provider, such as PayPal™, Inc. of San Jose, CA. A user 105, such as a consumer or a customer, may utilize user device 110 to perform an electronic transaction using payment provider server 170 and merchant server 140. For example, user 105 may utilize user device 110 to visit a merchant's web site provided by merchant server 140 or the merchant's brick-and-mortar store to browse for products offered by the merchant. Further, user 105 may utilize user device 110 to initiate a payment transaction, receive a transaction approval request, or reply to the request using payment provider server 170. Note that transaction, as used herein, refers to any suitable action performed using the user device, including payments, transfer of information, display of information, etc. Although only one merchant server is shown, a plurality of merchant servers may be utilized if the user is purchasing products from multiple merchants.

User device 110, merchant server 140, payment provider server 170, acquirer host 165, issuer host 168, and payment network 172 may each include one or more electronic processors, electronic memories, and other appropriate electronic components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, a smart phone with additional hardware such as NFC chips, BLE hardware etc., wearable devices with similar hardware configurations such as a gaming device, a Virtual Reality Headset, or that talk to a smart phone with unique hardware configurations and running appropriate software, laptop computer, and/or other types of computing devices capable of transmitting and/or receiving data, such as an iPad™ from Apple™.

User device 110 may include one or more browser applications 115 which may be used, for example, to provide a graphical interface to permit user 105 to browse information available over network 160. For example, in one embodiment, browser application 115 may be implemented as a web browser configured to view information available over the Internet, such as a user account for online shopping and/or merchant sites for viewing and purchasing goods and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 also may include other applications to perform functions, such as email, texting, voice and IM applications that allow user 105 to send and receive emails, calls, and texts through network 160, as well as applications that enable the user to communicate, transfer information, make payments, and otherwise utilize a digital wallet through the payment provider as discussed herein.

User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100. User device 110 may also include other applications 125, for example the mobile applications that are downloadable from the Appstore™ of APPLE™ or GooglePlay™ of GOOGLE™.

In conjunction with user identifiers 130, user device 110 may also include a secure zone 135 owned or provisioned by the payment service provider with agreement from the device manufacturer. The secure zone 135 may also be part of a telecommunications provider SIM that is used to store appropriate software by the payment service provider capable of generating secure industry standard payment credentials as a proxy to user payment credentials based on user 105's credentials/status in the payment providers system/age/risk level and other similar parameters.

Still referring to FIG. 1, merchant server 140 may be maintained, for example, by a merchant or seller offering various products, content, and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a purchase transaction may be payment or gift to an individual. Merchant server 140 may include a database 145 identifying available products, content, and/or services (e.g., collectively referred to as items) which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser applications over network 160 in order to view various products, food items, or services identified in database 145.

According to various aspects of the present disclosure, the merchant server 140 may also host a website for an online marketplace, where sellers and buyers may engage in purchasing transactions with each other. The descriptions of the items or products offered for sale by the sellers may be stored in the database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment provider server 170 over network 160. For example, checkout application 155 may receive and process a payment confirmation from payment provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Payment provider server 170 may be maintained, for example, by an online payment service provider which may provide payment services between user 105 and the operator of merchant server 140. In this regard, payment provider server 170 may include one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, usernames, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from user device 110 and/or merchant server 140 for processing and storage in a payment database 195. Transaction processing application 190 may include one or more applications to process information from user 105 for processing an order and payment using various selected funding instruments, as described herein. As such, transaction processing application 190 may store details of an order from individual users, including funding source used, credit options available, etc. Payment application 175 may be further configured to determine the existence of and to manage accounts for user 105, as well as create new accounts if necessary.

According to various aspects of the present disclosure, a Personalized Experience Generator (PEG) module 198 may also be implemented on the payment provider server 170. The PEG module 198 may include one or more software applications or software programs that can be automatically executed (e.g., without needing explicit instructions from a human operator) to perform certain tasks. For example, the PEG module 198 may detect a request from a user (e.g., the user 105) to interact with the payment provider server 170, which may be received via an online Help Center webpage, an Interactive Voice Response (IVR) system, a computer chatbot, an email, or another suitable communication channel. In response to the request, the PEG module 198 accesses the historical interactions between the user and the payment provider server 170 and then uses machine learning processes (e.g., based on NLP, XAI, and/or LLM) to predict the intent of the user in contacting the payment provider 170. For example, the PEG module 198 may include an NLP component, an XAI component, an LLM component, and/or another suitable machine learning component. In some embodiments, the various machine learning models of the PEG module 198 may be trained based at least in part on user data associated with one or more user activities of the user conducted with the payment provider server 170.

The PEG module 198 then generates a personalized experience for the user to address the predicted intent. For example, the PEG module 198 may provide a specific recommendation for the user or answer a specific question without being prompted by the user. The PEG module 198 may provide the personalized experience or content to the user via a suitable communication channel. The user may provide a response to the personalized experience, and the personalized experience may then be updated and communicated back to the user. It is understood that, since each user's intent may be different, the PEG module 198 may generate different experiences for different users. In addition, in some cases, a same user may make contact the payment provider server 170 at different times, and each time with a different intent. When that occurs, the PEG module 198 may generate different experiences for the same user at the different times as well. In this manner, the experience or content provided to each user is truly customized to specifically address that user's needs and/or concerns at that specific time.

Based on the above, the PEG module 198 may determine each user's intent without requiring the user to manually describe it, and the PEG module 198 may leverage such findings to automatically generate a personalized experience for the user. By doing so, the PEG module 198 can help a customer resolve an issue even before the customer needs to raise the issue. As such, electronic resources (e.g., computer processing power, electronic memory usage, network bandwidth) that would have been wasted (e.g., conducting an electronic chat sessions with the user) are now preserved. In this manner alone, the system 100 offers an improvement in computer technology.

It is noted that although the PEG module 198 is illustrated as being separate from the transaction processing application 190 in the embodiment shown in FIG. 1, the transaction processing application 190 may implement some, or all, of the functionalities of the PEG module 198 in other embodiments. In other words, the PEG module 198 may be integrated within the transaction processing application 190 in some embodiments. In addition, it is understood that the PEG module 198 (or another similar program) may be implemented on the merchant server 140, on a server of any other entity operating a social interaction platform, or even on a portable electronic device similar to the user device 110 (but may belong to an entity operating the payment provider server 170) as well. It is also understood that the PEG module 198 may include one or more sub-modules that are configured to perform specific tasks. For example, the PEG module 198 may include a sub-module configured to predict the intent of the customer and another sub-module configured to generate a message for the user as a part of the personalized experience.

Still referring to FIG. 1, the payment network 172 may be operated by payment card service providers or card associations, such as DISCOVER™, VISA™, MASTERCARD™, AMERICAN EXPRESS™, RUPAY™, CHINA UNION PAY™, etc. The payment card service providers may provide services, standards, rules, and/or policies for issuing various payment cards. A network of communication devices, servers, and the like also may be established to relay payment related information among the different parties of a payment transaction.

Acquirer host 165 may be a server operated by an acquiring bank. An acquiring bank is a financial institution that accepts payments on behalf of merchants. For example, a merchant may establish an account at an acquiring bank to receive payments made via various payment cards. When a user presents a payment card as payment to the merchant, the merchant may submit the transaction to the acquiring bank. The acquiring bank may verify the payment card number, the transaction type and the amount with the issuing bank and reserve that amount of the user's credit limit for the merchant. An authorization will generate an approval code, which the merchant stores with the transaction.

Issuer host 168 may be a server operated by an issuing bank or issuing organization of payment cards. The issuing banks may enter into agreements with various merchants to accept payments made using the payment cards. The issuing bank may issue a payment card to a user after a card account has been established by the user at the issuing bank. The user then may use the payment card to make payments at or with various merchants who agreed to accept the payment card.

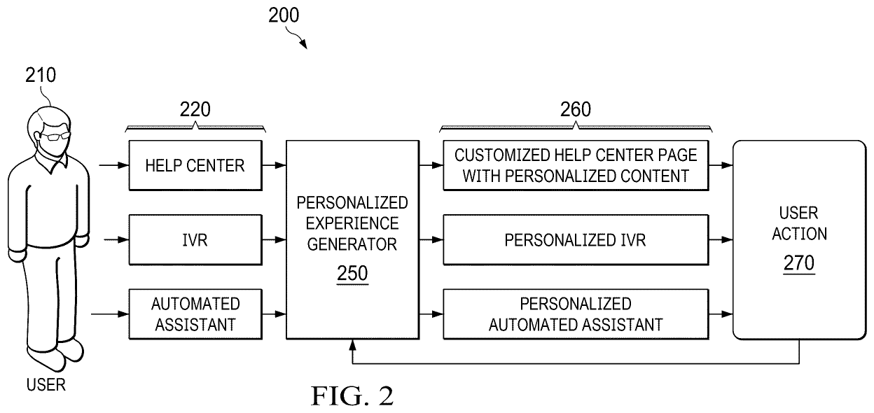

FIG. 2 illustrates a simplified block diagram corresponding to a process flow 200 for providing a personalized user experience (e.g., a user interface customized for the user) on an electronic platform according to embodiments of the present disclosure. The process flow 200 begins when a user 210 interacts with an electronic platform. In some embodiments, the electronic platform may include a third party payment provider like PayPal™ or another suitable entity operating the payment provider server 170. In some other embodiments, the electronic platform may include an online shopping platform, such as eBay™, Walmart™, Amazon™ or another suitable entity operating the merchant server 140. In yet other embodiments, the electronic platform may include a social networking platform, such as Facebook™, Instagram™, TikTok™, etc.

The user 210 may interact with the electronic platform via a plurality of communication channels 220. For example, one of the communication channels 220 may include a Help Center, which may include a section of a website of the electronic platform that is dedicated to answering various questions. In some embodiments, the Help Center may be displayed via a web page of the electronic platform and may include a list of Frequently Asked Questions (FAQ). Some example questions may include, but are not limited to: “How do I reset my password?”, “How do I cancel a payment?”, “How do I get a refund?”, “Why is my payment on hold?”, etc. The Help Center may also include answers for each of the questions. However, these questions and/or their corresponding responses may be generic and static (e.g., unchanging). For example, the questions and/or their corresponding responses do not change from user to user, and instead they may include the same content for all users (e.g., the user 210 and other users) who access the Help Center. Therefore, while the Help Center may be generally suitable for many users, it does not provide a customized solution for any individual user.

Another one of the communication channels 220 illustrated in FIG. 2 is an Interactive Voice Response (IVR) system. In some embodiments, the IVR system includes a telephone system that implements a menu of automated voice options. A caller (e.g., the user 210) may call into the telephone system and navigate through the menu, for example, by pressing different digits on the telephone. Via the IVR system, a user may perform different tasks, such as making various requests, obtaining information, providing responses, etc. In some embodiments, the IVR system may allow a user to speak with a live human agent as well. However, similar to the Help Center, the content of the IVR system may also be generic and static, and it may not be customized for individual users.

Yet another one of the communication channels 220 illustrated in FIG. 2 is an Automated Assistant. In some embodiments, the Automated Assistant may include a computer chatbot, which may be in the form of an autonomous computerized agent that has been deployed in various domains, including but not limited to customer support, data query, or technical assistance. The computer chatbot may have a back-and-forth electronic conversation with a user (e.g., the user 210), which may simulate a real conversation between a human agent and the user. Some advanced chatbots may be built on certain types of machine learning models, such as a Large Language Model (LLM), in order to better simulate the conversation with users. However, even though the Automated Assistant may have less generic or static responses compared to the Help Center or the IVR system, it may still not be fully customized for any individual user. For example, the Automated Assistant may not be able to accurately pinpoint the issue the user 210 is having, and as a result, the electronic conversations between the Automated Assistant and the user 210 may not be fully on point, which may leave the user 210 unsatisfied and subject to a much longer electronic conversation.

To address the inadequacies of the various communication channels 220, the present disclosure implements a personalized experience generator (PEG) 250 (e.g., as an embodiment of the PEG module 198 discussed above with reference to FIG. 1) to provide a more personalized experience or content for users such as the user 210. As will be discussed in greater detail below, in response to a request from the user 210 to interact with the electronic platform, the PEG 250 may access one or more machine learning models that are trained at least in part based on user data associated with the activities of the user 210 on the electronic platform. In some embodiments, the user data may be associated with the activities of the user 210 that took place via one or more of the communication channels 220. In other embodiments, the user data may be associated with activities of other users, who may have similar or same features as the user 210, such as item purchase, age, location, and/or other features that may help with predicting the intent of the user 210. The user data of other users may be especially beneficial if the user 210 has very little activity or history with or accessible by the electronic platform. The PEG 250 may then determine or predict an intent of the user 210 behind the request of the user 210 to interact with the electronic platform. Once the user intent is determined, the PEG 250 may then generate content that is customized to the user 210, which will specifically address the intent of the user 210. In some embodiments, the customized content may be in the form of one or more personalized messages, which may be in visual (e.g., textual or graphical) form, in audio form, or in audio/visual form (e.g., a video).

For example, the personalized message(s) may be communicated to the user 210 via personalized communication channels 260. One personalized communication channel 260 may include a customized Help Center page with personalized content. In other words, rather than displaying a generic and static list of questions and answers, the Help Center of the website of the electronic platform may display a list of questions and answers that are customized to the user 210, which may be directly targeted to the determined intent of the user 210. Such a list of questions and answers may be dynamically generated by the PEG 250 based on the results of machine learning. For example, if the predicted intent of the user 210 is to change the date of a payment, the dynamically generated Help Center of the communication channel 260 may include a short (compared to the Help Center of the communication channel 220) FAQ that includes questions and answers that walk the user 210 through how to change the date of the payment.

As another example, the personalized communication channel 260 may include a personalized prompt as a part of the IVR system. Again, rather than playing a fixed menu of options, the IVR system may play a menu of options customized to addressing the issue behind the determined intent of the user 210. For example, if the predicted intent of the user 210 is to change the date of a payment, the menu of options of the IVR system of the communication channel 260 may include a short (compared to the IVR menu of the communication channel 220) menu that includes prompts that, when selected by the user 210, allow the user 210 to change the date of the payment.

As yet another example, the personalized communication channel 260 may include a Personalized Automated Assistant (e.g., the computer chatbot) that can generate a personalized message or conversation with the user 210. For example, the computer chatbot may greet the user 210 in a manner that directly touches upon the determined intent of the user 210. In some embodiments, the personalized message may include a reference to a previous activity of the user 210. For example, suppose that the name of the user 210 is John, and that he had previously browsed a dispute page of a FAQ multiple times on a website of the electronic platform. The PEG 250 may have determined that the user 210 wishes to resolve a dispute. As such, the computer chatbot of the personalized communication channel 260 may display a personalized message that says, “Hi John! Thank you for being a loyal user of almost 5 years. I noticed that you have recently viewed our dispute FAQ page multiple times. Are you seeking information or assistance regarding the status of an open dispute?” The computer chatbot may also display a “Yes” button and a “Need help on something else” button for the user 210 to select in order to proceed.

Regardless of which of the specific communication channels 260 is used to interact with the user 210, the process flow 200 proceeds by detecting a user action 270. The user action 270 may be in the form of one or more clicks on a webpage (e.g., when the communication channel 260 is the customized Help Center), or one or more selections of audio menu options (e.g., when the communication channel 260 is the customized IVR, or a chat response (e.g., when the communication channel 260 is the Automated Assistant) from the user 210. Once the user action 270 is received, it may be fed back to the PEG 250. The PEG 250 may then execute the machine learning model(s) to generate an updated personalized experience. For example, if the user action 270 indicates that the determined user intent was correct, and that the user 210 needed additional information, the updated personalized experience may give instructions to the user 210 as to how to proceed to accomplish the user's goal. On the other hand, if the user action 270 indicates that the determined user intent was incorrect, then the user action 270 may offer additional insight on what the true intent was, and the PEG 250 may send the user 210 an updated personalized message, which may ask the user 210 to confirm the intent and/or how to achieve the intent. In any case, the updated personalized experience may be communicated to the user 210 via one or more of the communication channels 260 again. This loop described above may continue until the user 210 is satisfied with the result.

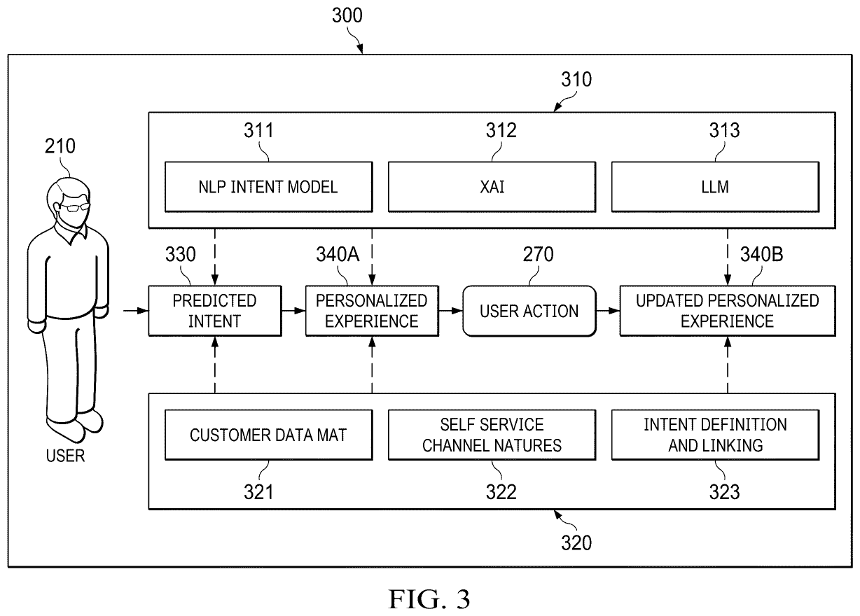

Referring now to FIG. 3, a block diagram of a system 300 of the present disclosure is illustrated. In some embodiments, the system 300 includes an omni channel context management system, one or more aspects of which may be used to implement the PEG 250 of FIG. 2. The system 300 comprises a plurality of machine learning models 310, such as a Natural Language Processing (NLP) Intent model 311, an Explainable Artificial Intelligence (XAI) model 312, and a Large Language Model (LLM) 313. The plurality of machine learning models 310 may be trained based at least in part on user data associated with one or more user activities of the user 210 on the electronic platform. The system 300 also comprises various types of analytical data 320, such as Customer Data Mat 321, Self Service Channel Natures 322, and Intent Definition & Linking 323. The plurality of machine learning models 310 and the various types of analytical data 320 may be used to generate a personalized experience for a user, such as the user 210.

In more detail, the user 210 may interact with the system 300, for example, via one of the communication channels 220 discussed above with reference to FIG. 2. For example, the user 210 may provide input via the Help Center, the IVR system, or the Automated Assistant. The system 300 may first determine an intent of the user 210. For example, the system 300 may generate a Predicted Intent 330 based on the NLP intent model 311 and the Customer Data Mat 321. In that regard, the NLP intent model 311 involves using the capabilities of machine learning to interpret, manipulate, and comprehend human language. One example NLP technique is word2vec, which is a group of related models that are used to produce word embeddings. The models may be shallow, two-layer neural networks that are commonly used to reconstruct linguistic contexts of words of a given language in a compact form. For a given vocabulary of words, word2vec creates “word embeddings”—mapping from each word to an n-dimensional vector. For example, “king” may be mapped to a five-dimensional vector with the value [0.8, 0.65, 1.7, 2, 4]. The word embeddings are created using the context in which the word appears, as the words that tend to appear next to it. Therefore, it is expected that words that appear in similar contexts will have similar vectors (e.g., sentences “I really like cooking in the kitchen” and “I really like baking in the kitchen”). Word2vec may take, as its input, a large corpus of text and produces a vector space, typically of several hundred dimensions (e.g., 300 dimensions to represent the English vocabulary). Each unique word in the corpus is assigned a corresponding vector in the space. Word vectors are positioned in the vector space such that words that share common contexts in the corpus are located in close proximity to one another in the space. Other embedding and training algorithms such as FastText may be used similarly like word2vec as understood by one of ordinary skill in the art. In some embodiments, sentence and/or paragraph vectors may be calculated in addition to word vectors. Periodically (e.g., weekly, monthly, etc.), word2vec may be run on data from the most recent period of time (e.g., week, two weeks, month, two months, six months, year, etc.) during which the user 210 has interacted (e.g., uttered words) with the electronic platform. It is understood that other NLP techniques in conjunction with, or instead of, word2vec in order to predict the intent of the user 210.

In the example of FIG. 3, the corpus of text used to train the NLP Intent Model 311 may include the Customer Data Mat 321. In that regard, the Customer Data Mat 321 may include feature data pertaining to previous engagements of the user 210 (as well as other users) with the electronic platform. For example, such feature data may include, but is not limited to: the content of the previous chats and/or messages exchanged between the user 210 and the electronic platform, the frequency of engagement of the user 210 with the electronic platform, the frequency of transactions conducted by the user 210, the amount of transactions conducted by the user 210, how often the transactions conducted by the user 210 are declined, any limitations placed on the account of the user 210, the credit score of the user 210, login credentials of the user 210, a physical address associated with the user 210, a phone number associated with the user 210, the Internet Protocol (IP) address of the device used by the user 210 to engage with the electronic platform, an email address associated with the user 210, a domain name of the email address, a username of the email address, etc. The textual content can be extracted from the Customer Data Mat 321 to help train the NLP Intent Model 311. The trained NLP Intent Model 311 may then be used to generate the Predicted Intent 330, which may be in the form of a prediction made by the NLP Intent Model 311. For example, the Predicted Intent 330 may indicate that the user 210 wishes to change a date of a payment.

Still referring to FIG. 3, based on the Predicted Intent 330, the system 300 may utilize the XAI model 312 and the Self Service Channel Natures 322 to generate a Personalized Experience 340A for the user 210. In that regard, the XAI model 312 may comprise a set of methods and/or processes that are executed to help an operator (e.g., a human) understand the results and/or reasoning of a particular machine learning algorithm in making a given prediction (e.g., the Predicted Intent 330). Various techniques and/or models used in XAI may include, but are not limited to: Decision Trees, Linear Regression, K-Nearest Neighbors, Decision Rules, Local Interpretable Model-agnostic Explanations (LIME), SHapley Additive exPlanation (SHAP), Partial Dependence Plots, Individual Conditional Expectation, Counterfactual Explanations, Surrogate Models, Saliency Maps, Gradient-weighted Class Activation Mapping, Layer-wise Relevance Propagation (LRP), Attention Mechanisms, Neural Network Feature Importance, Casual Trees/Forest, Feature Importance, Markov-Chains, etc.

Regardless of the particular manner in which the XAI model 312 is implemented, it may be used to generate clear explanations for a particular piece of feature data identified as being important and/or for a particular prediction (e.g., the Predicted Intent 330) made by machine learning models (e.g., the NLP Intent Model 311). For example, suppose that the XAI model 312 has identified a feature idi_ipv4_context_vars_time_snc_disp_faq_viewed as the most important feature from the Customer Data Mat 321. A human operator may not intuitively understand what this feature entails, and/or why it has been identified as the most important feature. The XAI model 312 may explain that this feature measures the time since the user viewed a dispute-related FAQ page, which is likely to be a recent interaction with the dispute resolution process of the electronic platform. As another example, suppose that the XAI model 312 has identified a feature acct_cntct_p_f_non_issuer_cnt_sw72_72h as the most important feature from the Customer Data Mat 321. The XAI model 312 may explain that this feature is important because within the last 72 hours, a user has contacted the customer service of the electronic platform multiple times due to failed non-issuer payments, and that this feature tracks the count of these failed attempts.

Meanwhile, the Self Service Channel Natures 322 may include data that indicates or specifies how information should be communicated to different users (or different classes/groups of users) differently across the plurality of communication channels 220. For instance, the Self Service Channel Natures 322 may include data that specifies how a user interface of the Help Center (e.g., one of the example communication channels 220 discussed above with reference to FIG. 2) should be configured differently for different users. As a simple example, the Help Center of the communication channels 220 may display different content than the IVR of the communication channels 220, which may each display different content than the computer chatbot of the communication channels 220. In each of the cases, the specific communication channel 220 may be configured to communicate the desired message in a manner that is best suited for that communication channel 220. As another example, the differences in the content of the messages may be configured at least in part based on the respective data (e.g., obtained from the Customer Data Mat 321) associated with the different users. For instance, the Help Center of the communication channels 220 may display one set of menu options for a visually impaired user when that visually impaired user initially accesses the Help Center, but it may display another (and different) set of menu options for another user who is not visually impaired when the another user initially accesses the Help Center. In this case, the visual impairment (or the lack thereof) may be part of the data obtained from the Customer Data Mat 321.

Regardless of the particular types of data included in the Self Service Channel Natures 322, the system 300 is able to utilize it, in conjunction with the Predicted Intent 330 and the XAI model 312, to generate the Personalized Experience 340A. The Personalized Experience 340A may be communicated to the user 210A through one or more of the personalized communication channels 260. For example, the Personalized Experience 340A may include a customized Help Center page of the personalized communication channel 260, where the list of questions and answers are not generic, but are specifically customized to the user 210A to address the Predicted Intent 330. As a simple example, if the Predicted Intent 330 for the user 210A is to change the date of an upcoming payment, then the personalized Help Center page of the personalized communication channel 260 may display the list of questions and answers for how to change the date of an upcoming payment, rather than generic questions and answers pertaining to issues that are not determined to be relevant to the user 210A currently (e.g., how to change a username or password, or how to file a dispute, etc.). Similarly, the personalized IVR system of the personalized communication channel 260 may play an audio recording of menu options that are specifically configured to address the Predicted Intent 330 (e.g., how to change a payment date) for the user 210, and the Personalized Automated Assistant of the personalized communication channel 260 may generate a message or have a conversation with the user 210 to specifically address the Predicted Intent 330, as a part of the Personalized Experience 340A.

Still referring to FIG. 3, after the Personalized Experience 340A has been provided to the user 210, the system 300 may detect or otherwise receive the User Action 270 discussed above with reference to FIG. 2. As discussed above, the User Action 270 may be in the form of one or more clicks on a webpage, one or more selections of audio menu options, text in an electronic chat, or other means to receive input from the user 201. In some embodiments, the User Action 270 may include a confirmation or a rejection of the Predicted Intent 330. Based on the User Action 270, the system 300 may generate an Updated Personalized Experience 340B. The generation of the Updated Personalized Experience 340B may utilize the LLM 313 and the Intent Definition and Linking 323.

In more detail, the LLM 313 is a particular type of AI model that is designed to understand and generate human language. The LLM 313 may have a large number of parameters, which may include components with adjustable attributes. Non-limiting examples of LLM parameters may include: weights, attention weights, biases, positional encoding, layer normalization, embedding mapping, feed-forward neural network parameters, transformer layer parameters, decoder parameters, encoder parameters, projection matrices, etc. The LLM 313 may be trained on a variety of sources, and it may use a neural network architecture. In some embodiments, the LLM 313 may be implemented using a Generative Pre-trained Transformer (GPT), a Bidirectional Encoder Representation from Transformers (BERT), a Text-To-Text Transfer Transformer (T5). The LLM 313 may be used to generate human-like speech, perform translations, provide summaries, analyze sentiments, and/or power computer chatbots.

The Intent Definition & Linking 323 may include data pertaining to a plurality of intent groups and their linking. For example, the system 300 may implement an M number (e.g., between 10 and 50) of “big” intent groups and an N number (e.g., between 200 and 1000) of “small” intent groups. Each intent group may correspond to a specific user intent, and each “big” intent group may be further divided into one or more of the “small” intent groups. In some embodiments, the “big” intent group may correspond to an intent at a higher or a more general level, while the “small” intent group may correspond an intent at a lower or a more specific level. For example, a “big” intent group may correspond to “the user has a payment-related issue,” and a “small” intent group may correspond to “the user wishes to change a date of an upcoming payment.” The Intent Definition & Linking 323 also contains data that links the various intent groups together. Furthermore, the Intent Definition & Linking 323 may also include data that identifies the top features that contribute to any given intent.

In any case, based on the User Action 270, the system 300 may utilize the LLM 313 and the Intent Definition & Linking 323 to generate the Updated Personalized Experience 340B. The Updated Personalized Experience 340B may be similar to the Personalized Experience 340A in form, but different in the underlying content. For example, the Personalized Experience 340A may be to provide the user 210 with options to cancel a payment, but when the User Action 270 indicates that this is not the user's intent, the Updated Personalized Experience 340B may be to provide the user 210 with options to change a date of an upcoming payment. In some embodiments, the Predicted Intent 330 and the top solutions may be re-ranked based on the feedback obtained from the User Action 270, which may then help generate a more accurate Updated Personalized Experience 340B. In another embodiment, the Updated Personalized Experience 340B maybe similar in content to the Personalized Experience 340A, but different in form. For example, User Action 270 may indicate the user is unable read or hear the content, such as if the user is in a loud area or the user is using a computing device with a very small display, such as a smart watch. In such cases, the form of the content delivery can be changed.

In some embodiments, the XAI model 312 and/or the LLM 313 may also be used to generate the Predicted Intent 330. In some embodiments, the NLP Intent Model 311 and/or the LLM 313 may also be used to generate the Personalized Experience 340A or the Updated Personalized Experience 340B. Similarly, the Customer Data Mat 321, the Self Service Channel Natures 322, and/or the Intent Definition & Linking 323, or portions thereof, may be used to help generate the Predicted Intent 330, the Personalized Experience 340A, and/or the Updated Personalized Experience 340B. In other words, the generation of the Predicted Intent 330, the Personalized Experience 340A, or the Updated Personalized Experience 340B may rely on more than one type of machine learning model, as well as more than one type of analytical data, in various embodiments.

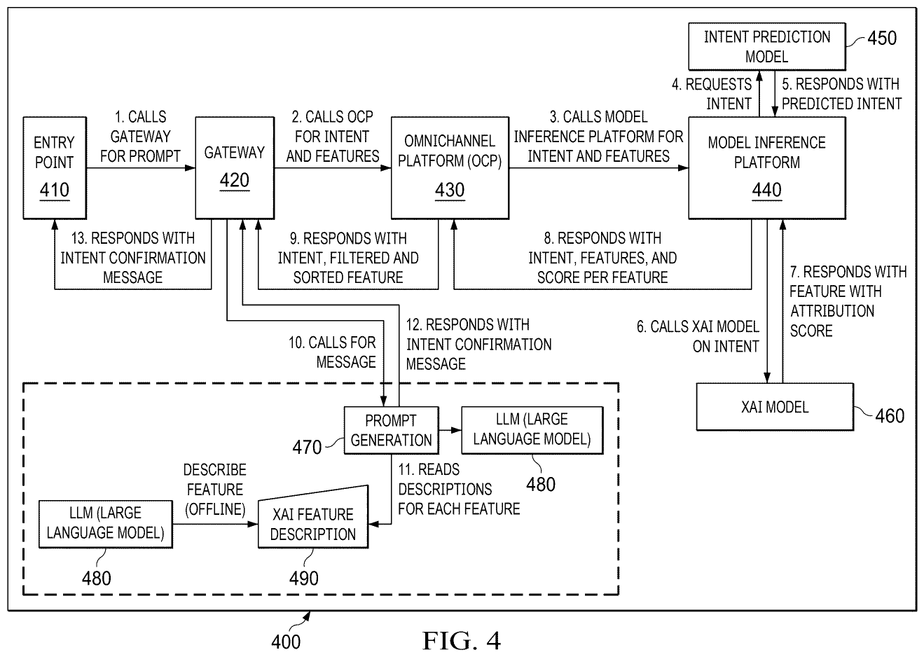

FIG. 4 is a block diagram of a process flow 400 that illustrates various aspects of the present disclosure at a lower level than the process flow 200. At an entry point 410, information is received from a user (e.g., the user 210 discussed above with reference to FIGS. 2-3). At a step 1 of the process flow 400, the entry point 410 calls a gateway 420 for a prompt. In some embodiments, the entry point 410 may include one or more of the communication channels 220 discussed above with reference to FIG. 2. The gateway 420 itself need not generate intent predictions or a personalized experience. Instead, the gateway 420 may include hardware and/or software for calling other components to perform these tasks. For example, in a step 2 of the process flow 400, the gateway 420 calls an omnichannel platform 430 (OCP) for intents and features. The OCP 430 may include an electronic storage that stores information corresponding to previous user interactions with the electronic platform, regardless of via which communication channel the interaction took place. In this manner, once the user has provided certain information via one communication channel, the user need not have to repeat that information via another communication channel, since that information has already been captured by the OCP 430.

In a step 3 of the process flow 400, the OCP 430 calls a Model Inference Platform 440 for intent and features. The intent may refer to the predicted user intent discussed above with reference to FIGS. 2-3, and the features may include features such as the frequency of engagement of the user with the electronic platform, the frequency of transactions conducted by the user, the amount of transactions conducted by the user, how often the transactions conducted by the user are declined, any limitations placed on the account of the user, the credit score of the user, login credentials of the user, a physical address associated with the user, a phone number associated with the user, the Internet Protocol (IP) address of the device used by the user to engage with the electronic platform, an email address associated with the user, a domain name of the email address, a username of the email address, etc.

In a step 4 of the process flow 400, the Model Inference Platform 440 requests an intent from an Intent Prediction Model 450. In some embodiments, the Intent Prediction Model 450 may include (or may be an embodiment of) the NLP Intent Model 311 discussed above with reference to FIG. 3. For example, the Intent Prediction Model 450 may utilize NLP to analyze the speech patterns of the user, which may then be leveraged to determine or otherwise predict the intent of the user. In a step 5 of the process flow 400, the Intent Prediction Model 450 responds to the Model Inference Platform 440 with the predicted intent.

In a step 6 of the process flow 400, the Model Inference Platform 440 calls an XAI model 460 regarding the predicted intent. In some embodiments, the XAI model 460 may include (or may be an embodiment of) the XAI model 312 discussed above with reference to FIG. 3. The XAI model 460 may provide an explanation regarding the predicted intent. For example, the XAI model 460 may determine which feature(s) may be the most responsible for the predicted intent. In some embodiments, the features may each be assigned an attribution score that indicates how important that particular feature is in contributing to the predicted intent, and the features may be ranked according to their respective attribution scores. The feature (or a set of features) with the highest score may then be returned by the XAI model 460 to the Model Inference Platform 440 in a step 7 of the process flow 400.

In a step 8 of the process flow 400, the Model Inference Platform 440 responds to the OCP 430 with the predicted intent (e.g., obtained from the Intent Prediction Model 450), as well one or more features that contribute the most to the predicted intent and their respective scores (e.g., obtained from the XAI Model 460). In a step 9 of the process flow 400, the OCP 430 may then respond to the gateway 420 with the predicted intent, as well as a list of filtered and sorted features. The filtering and/or sorting of the features may be performed by the OCP 430 in some embodiments, or by the Model Inference Platform 440 in other embodiments.

In a step 10 of the process flow 400, the Gateway 420 calls for message from a Prompt Generation module 470. In some embodiments, the Prompt Generation module 470 may interact with, or include, an LLM 480 to generate a prompt. In some embodiments, the LLM 480 may include (or may be an embodiment of) the LLM 313 discussed above with reference to FIG. 3. In a step 11 of the process flow 400, the Prompt Generation module 470 reads the descriptions for each feature and may generate an XAI feature description 490. This may be achieved at least in part via the LLM 480. In some embodiments, the LLM 480 may describe the features offline.

In a step 12 of the process flow 400, the Prompt Generation module 470 responds to the Gateway 420 with an intent confirmation message. The Gateway 420 then responds to the Entry Point 410 with the intent confirmation message. In some embodiments, the intent confirmation message may be the personalized message discussed above with reference to FIGS. 2-3.

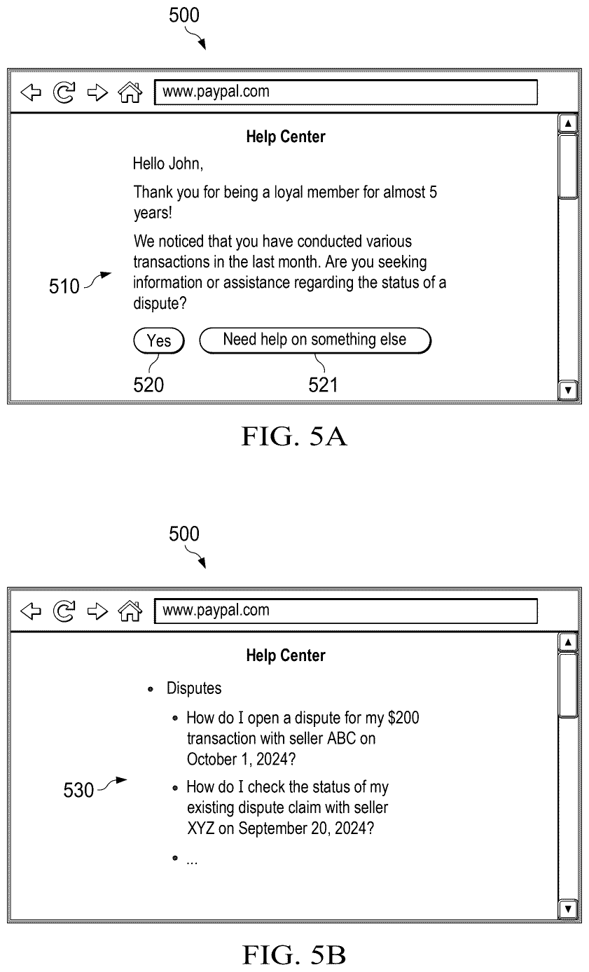

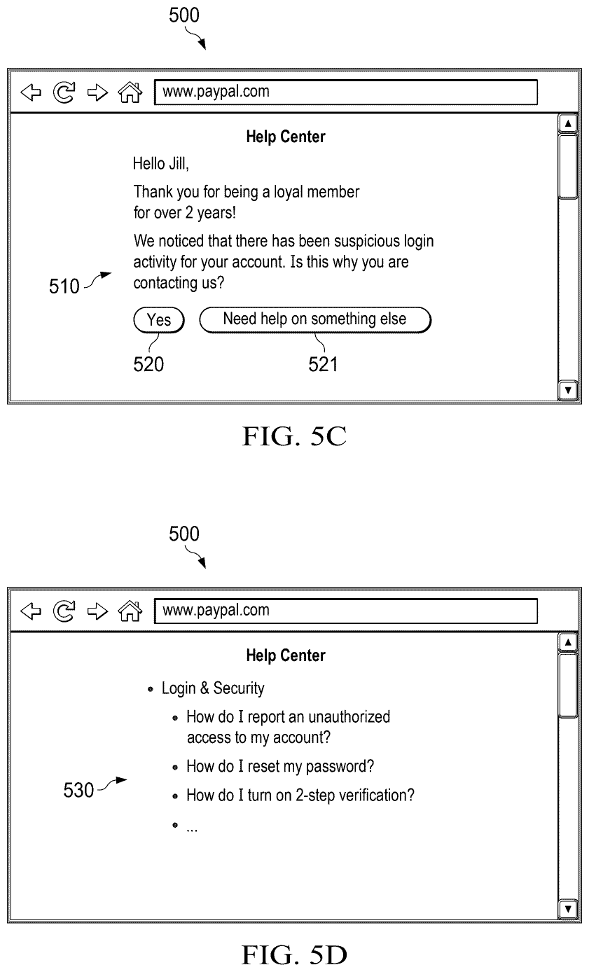

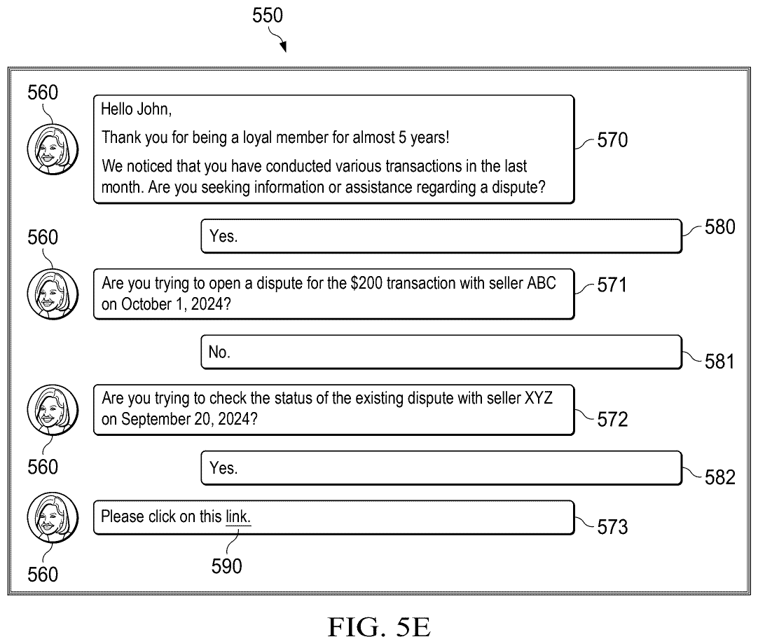

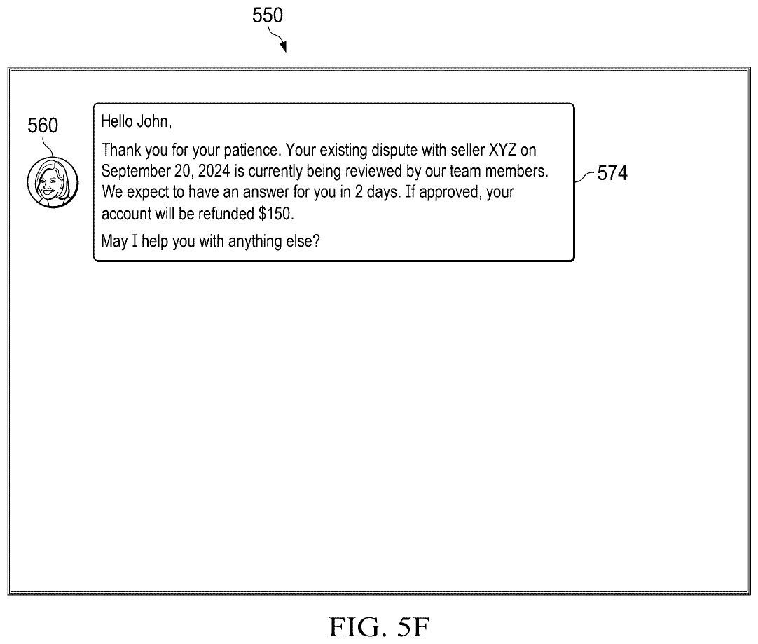

FIGS. 5A-5F illustrate a series of example user interfaces that are dynamically generated to provide a personalized experience or content for a user. For example, FIGS. 5A-5D illustrate a dynamically generated user interface 500 of an electronic platform. In some embodiments, the user interface 500 comprises a particular webpage of a website of the electronic platform, which is PayPal™ in this case. The particular webpage displayed in FIGS. 5A-5D is a Help Center, which in conventional implementations, typically includes a list of frequently asked questions (FAQ) and their respective answers in a generic manner (e.g., the same to all users). In contrast, the Help Center herein is individually customized for the visiting user. For example, after the user (John in this example) has logged in to PayPal. com and visits the Help Center, the user interface 500, in FIG. 5A, may display a personalized welcome message 510 that states, “Hello John, Thank you for being a loyal member for almost 5 years! We noticed that you have conducted various transactions in the last month. Are you seeking information or assistance regarding the status of a dispute. Are you seeking information or assistance regarding the status of a dispute?”

Such a personalized welcome message 510 may be generated by the PEG 250 or the system 300 discussed above, which may utilize various machine learning techniques (e.g., NLP, XAI, LLM, etc.) and the user's historical interactions with PayPal™ to generate the personalized message 510. For example, the PEG 250 or the system 300 may utilize machine learning and the user's historical interactions with PayPal™ to predict the intent of the user, which is to seek information or assistance regarding the status of a dispute. To help the user understand the context, the personalized message 510 also includes a reference to a past activity of the user with PayPal™, for example, the fact that the user has recently conducted various transactions over the last month.

The user interface 500 in FIG. 5A may also include a confirmation button 520 (saying “Yes”) and a rejection button 521 (saying “Need help on something else”) for the user to select. If the user selects the rejection button 521, this is a form of the user action 270 (discussed above with reference to FIG. 3), and it may be used to provide the updated personalized experience 340B (see FIG. 3) for the user. For example, the PEG 250 or the system 300 may re-determine the user intent, and the user interface 500 may display an updated personalized welcome message 510 that includes a reference to the re-determined user intent.

On the other hand, if the user selects the confirmation button 520, this is also a form of the user action 270 (see FIG. 3). Again, the PEG 250 or the system 300 may update the personalized experience 340B, for example, by updating the user interface 500 as shown in FIG. 5B. In some embodiments, the updated user interface 500 may include a list of dynamically generated menu options 530 that pertain not only to disputes, but that are also specifically targeted to specific transactions that the user may have conducted, for which a dispute may or may not have been opened yet. For example, one of the menu options 530 may contain a link “How do I open a dispute for my $200 transaction with seller ABC on October 1, 2024?” This refers to a recent transaction conducted by the user, for which the user may open a dispute claim. If the user clicks on this option, then the user interface 500 may display detailed instructions and/or web links instructing the user on how to open the dispute associated with this particular transaction. As another example, another one of the menu options 530 may contain a link “How do I check the status of my existing dispute claim with seller XYZ on September 20, 2024?” If the user clicks on this option, then the user interface 500 may display detailed instructions and/or web links instructing the user on how to check the status of the dispute associated with this particular transaction. Other suitable menu options may be included in the menu options 530, but they are not specifically shown or discussed herein for reasons of simplicity.

In some embodiments, the user interface 500 may be dynamically reconfigured to provide a simplified user experience. For example, menu options that do not specifically pertain to user disputes may not be displayed by the user interface 500. In that regard, a Help Center page may commonly include options pertaining to login, payments, account information, etc., in addition to disputes. However, since the user intent has already been determined (and/or even confirmed by the user) as being pertaining to disputes, the user interface 500 may omit these other options in the menu options 530 displayed by the user interface 500, so that the user can focus on getting his specific issue addressed, which is how to open a dispute and/or to check on the status of an existing dispute.

As discussed above, the user interface 500 is dynamically generated for each individual user to address that individual user's needs and/or concerns at that time. As such, different users accessing the Help Center page may be shown different user interfaces. For example, referring now to FIG. 5C, after a different user (Jill in this example) has logged in to PayPal. com and visits the Help Center, the user interface 500 may display a personalized welcome message 510 that states, “Hello Jill, Thank you for being a loyal member for over 2 years! We noticed that there has been suspicious login activity for your account. Is this why you are contacting us?” Again, such a personalized welcome message 510 is customized to the user Jill based on her previous interactions with PayPal™, and as such, the predicted intent for Jill is different than the predicted intent for John, and the content of the personalized message 510 for Jill is different than the content of the personalized message 510 for John (see FIG. 5A).

The user interface 500 may still include the confirmation button 520 and the rejection button 521, and the user Jill may also provide feedback to the PEG 250 or the system 300 discussed above by clicking on either of the buttons 520 and 521. Since the predicted intent for the user Jill is different than that for the user John, the subsequent content of the user interface 500 may be different too, depending on the selection made by the user Jill. For example, assuming that the user Jill selects the confirmation button 520 in response to the personalized message 510, the user interface 500 may display a dynamically generated list of menu options 530 that pertain to the user account login & security. For example, one of the menu options 530 may contain the links of “How do I report an unauthorized access to my account?”, “How do I reset my password?”, “How do I turn on 2-step verification?”, etc. Each of the links, when clicked on by the user Jill, may include answers and/or instructions informing the user Jill on how to address that specific issue.

It is understood that although the user interface 500 discussed above in association with FIGS. 5A-5D illustrates the personalized experiences for different users, it may apply to the same underlying user as well. For example, suspicious login activity may have also affected the user John before or after the user John has resolved the dispute issue. As such, when the user John logs into his PayPal™ account a second time (e.g., the first time to resolve the dispute issue), the user interface 500 may display the personalized message 510 (or something similar) of FIG. 5C, so that the user John may have an opportunity to resolve a login-related issue quickly. Again, this may be a result of the PEG 250 or the system 300 having determined that, based on the various machine learning models and the user John's previous user activity, the most likely intent of him contacting PayPal™ at this time is to resolve a login-related issue, rather than to resolve a dispute-related issue. Accordingly, the user interface 500 is updated to reflect this new determination, and the user John may access one or more of the links displayed in the list of menu options 530 (or something similar) in FIG. 5D to resolve the login-related issue.

FIG. 5E illustrates another example of a dynamically generated user interface 550 of the electronic platform for providing a personalized experience for a user. In the embodiment of FIG. 5E, the user interface 550 is a user interface of an automated assistant implemented by the electronic platform, for example, in the form of a computer chatbot 560 that is driven by AI and not directly by humans. In other words, the words spoken/uttered by the computer chatbot 560 in FIG. 5E are automatically generated by a computer, rather than being written by a human operator.

Suppose that the user in this case is also the user John discussed above with reference to FIGS. 5A-5B, who wishes to address a dispute. A conventional computer chatbot (e.g., one that is not implemented according to the various aspects of the present disclosure) may greet the user with a generic message, such as “Hello, I am your assistant and am always here to help. How may I help you?” Such a message lacks any degree of personalization, and the user may have to explain in detail why he is chatting with the computer chatbot and/or what issues are of his concern, which may be cumbersome for the user. This is because existing computer chatbots do not or cannot accurately predict the underlying intent of the user when the user contacts the electronic platform, and as such, any message generated by the existing computer chatbot may not be personalized for the user and may lack relevant details in its generated content.

In contrast, the computer chatbot 560 can generate personalized messages and/or display the personalized messages generated by the PEG 250 or the system 300 discussed above. For example, the computer chatbot 560 may first greet the user with a personalized message 570 that states, “Hello John, Thank you for being a loyal member for almost 5 years! We noticed that you have conducted various transactions in the last month. Are you seeking information or assistance regarding a dispute?” Similar to the personalized message 510 as a part of the Help Center discussed above with reference to FIG. 5A, the personalized message 570 in FIG. 5E also contains a reference to the user's previous activity (e.g., conducting various transactions in the last month), and it also includes a predicted intent of the user (e.g., seeking information or assistance regarding the status of a dispute). Such a personalized message 570 may be an example of the personalized experience 340A discussed above with reference to FIG. 3.

Suppose that the user then types “Yes” as a reply 580 to the personalized message 570. The reply 580 may be an example of the user action 270 discussed above with reference to FIGS. 2-3. The computer chatbot 560 (or the PEG 250 or the system 300) may then update the predicted intent and generate an updated personalized message 571, which may state, “Are you trying to open a dispute for the $200 transaction with seller ABC on October 1, 2024?” The personalized message 571 may be an example of the updated personalized experience 340B discussed above with reference to FIG. 3. The message 571 is even more personalized to the user, since it is now addressing a specific transaction that may be causing a dispute, whereas the message 570 deals with disputes in general. This is because the user intent has been updated from “seeking information or assistance regarding a dispute” to “open a dispute for the $200 transaction with seller ABC on October 1, 2024.”

Suppose that the user then types “No” as a reply 581 to the personalized message 571. The reply 581 may be another example of the user action 270 discussed above with reference to FIGS. 2-3. The computer chatbot 560 (or the PEG 250 or the system 300) may again update the predicted intent and generate another updated personalized message 572, which may state, “Are you trying to check the status of the existing dispute with seller XYZ on September 20, 2024?” The personalized message 572 may be another example of the updated personalized experience 340B discussed above with reference to FIG. 3. Again, based on the reply 581 (e.g., as a user action 270), the user intent has been updated again from “open a dispute for the $200 transaction with seller ABC on October 1, 2024” to “check the status of the existing dispute with seller XYZ on September 20, 2024.”

Suppose that the user then types “Yes” as a reply 582 to the personalized message 572. The reply 582 may be yet another example of the user action 270 discussed above with reference to FIGS. 2-3. The computer chatbot 560 (or the PEG 250 or the system 300) may generate another updated personalized message 573, which may state, “Please click on this link”, which contains an embedded link 590 that is clickable. The personalized message 573 may be yet another example of the updated personalized experience 340B discussed above with reference to FIG. 3. The link 590, when clicked by the user, may display additional information about the transaction (e.g., date, amount, parties involved in the transaction, etc.) and/or about the dispute itself (e.g., the date on which the dispute was filed, the nature of the dispute, and the current status of the dispute). In some embodiments, clicking on the link 590 may open a new webpage on which the additional information about the transaction is displayed.

Alternatively, the computer chatbot 560 may state the additional information directly without giving the user the link 590. For example, in an alternative embodiment shown in FIG. 5F, the computer chatbot 560 may state, in an updated personalized message 574, “Hello John, Thank you for your patience. You existing dispute with seller XYZ on Sep. 20, 2024 is currently being reviewed by our team members. We expect to have an answer for you in 2 days. If approved, your account will be refunded $150. May I help you with anything else?” Additional interactions between the user and the computer chatbot 560 may continue, but they are not specifically discussed herein for reasons of simplicity.

FIGS. 5A-5F illustrate dynamically generated personalized user interfaces with visual content (e.g., web pages or electronic chats). However, the dynamically generated personalized user interfaces may be in the form of audio as well. For example, when a user calls into a conventional IVR systems, it may play a list of generic user-selectable options, such as “press 1 if you are calling to access your funds”, “press 2 if you are calling to close your account”, “press 3 if you are calling to file a dispute”, etc. In contrast, the IVR system of the present disclosure may play a personalized audio message of “Hi John, Thanks for calling us. Based on our review of your account, it looks like you have some concerns regarding your recent transactions. Do you recognize the transaction from Nike for $50?” If the user says “no” or presses a button on the phone that corresponds to saying “no”, then the IVR system may play another personalized audio message of “Would you like to file a dispute for this transaction?” The above is merely a simplified example of the IVR system of the present disclosure, and it is understood that the IVR system may have capabilities equivalent (or similar) to that of the computer chatbot 560 in some embodiments, but that the delivery of the content of the personalized message is in audio form for the IVR system (as opposed to visual form for the computer chatbot 560).

Based on the above discussions, it can be seen that the present disclosure can generate and provide personalized experiences for different users, for example, by using machine learning to predict the underlying intent of each of the users and proactively offering solutions for resolving the issues that concern the users, without requiring the users to specifically describe the issues manually. In this manner, the present application is a practical application of the idea of providing customer service. In such a practical application, the personalized experience that is automatically generated for the user does not adopt a generic one-size-fits-all approach, but rather tailors the experience to the predicted needs and/or concerns of the user. In embodiments where the personalized experience is in a form of a webpage or an electronic chat provided by a computer chatbot, the textual content of the webpage or the chat is specifically configured to proactively address the predicted issues that concern the user. As such, the user is spared of having to wade through numerous links (e.g., of a FAQ page) that are irrelevant to the user's particular concern, or having to chat with a computer chatbot, which may be time-consuming. Similarly, in embodiments where the personalized experience is in the form of an IVR call, the audio content of the IVR call is also specifically configured to address the user's particular concern, and it may spare the user of having to listen to numerous voice menu options that are irrelevant to the user's concern. Furthermore, in all of the above situations, the textual or audio content may be simplified at least in part by omitting options that are predicted to be outside of the user's immediate concern, which may allow the user to reach a resolution even more quickly. Consequently, user satisfaction may be improved, and less time and resources are needed to address the back-and-forths of typical customer support sessions.

Furthermore, the present disclosure is an improvement of computer technology, as conventional methods and techniques lack the capability to accurately predict the user intent without requiring the user to specifically describe the intent in detail. By using machine learning and the user's prior activity on the electronic platform, the present disclosure may predict the user intent with sufficient accuracy, which then allows personalized messages to be communicated to the user, where the predicted user intent is specifically addressed. In this manner, the present disclosure improves computer efficiency and reduces electronic waste, since maintaining a conventional electronic chat session between a customer and a customer service agent would have consumed (and wasted) computer resources (e.g., computer processing power, electronic memory usage, electronic communication bandwidth, etc.), and the same is true for hosting a generic Help Center webpage or a generic IVR system, which the user may have to access many times before finding a suitable solution. The present disclosure also frees up not only human customer service agents from having to chat with customers, but also computerized bots too. In other words, whereas conventional customer support mechanisms would have required a great deal of computer resources, the present disclosure can achieve faster solutions for the user's concerns while requiring less computer resources, which is a part of the improvement in computer technology.

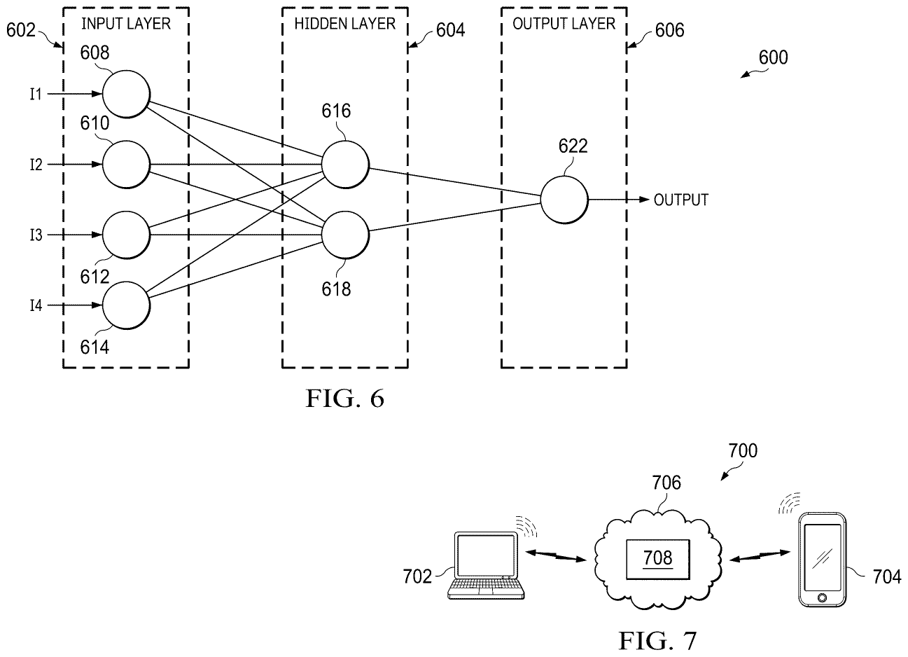

As discussed above, machine learning may be used to predict the intent of the customer and/or to generate the personalized experience for a user. In some embodiments, the machine learning may be performed at least in part via an artificial neural network, which may be used to implement a machine learning module that can perform at least some of the machine learning processes discussed above. In that regard, FIG. 6 illustrates an example artificial neural network 600. As shown, the artificial neural network 600 includes three layers—an input layer 602, a hidden layer 604, and an output layer 606. Each of the layers 602, 604, and 606 may include one or more nodes. For example, the input layer 602 includes nodes 608-614, the hidden layer 604 includes nodes 616-618, and the output layer 606 includes a node 622. In this example, each node in a layer is connected to every node in an adjacent layer. For example, the node 608 in the input layer 602 is connected to both of the nodes 616-618 in the hidden layer 604. Similarly, the node 616 in the hidden layer is connected to all of the nodes 608-614 in the input layer 602 and the node 622 in the output layer 606. Although only one hidden layer is shown for the artificial neural network 600, it has been contemplated that the artificial neural network 600 used to implement a part of the PEG module 198, and the PEG module 198 may include as many hidden layers as necessary.

In this example, the artificial neural network 600 receives a set of input values and produces an output value. Each node in the input layer 602 may correspond to a distinct input value. For example, when the artificial neural network 600 is used to implement a machine learning module, each node in the input layer 602 may correspond to a distinct attribute of an analyzed language usage pattern of a user.

In some embodiments, each of the nodes 616-618 in the hidden layer 604 generates a representation, which may include a mathematical computation (or algorithm) that produces a value based on the input values received from the nodes 608-614. The mathematical computation may include assigning different weights to each of the data values received from the nodes 608-614. The nodes 616 and 618 may include different algorithms and/or different weights assigned to the data variables from the nodes 608-614 such that each of the nodes 616-618 may produce a different value based on the same input values received from the nodes 608-614. In some embodiments, the weights that are initially assigned to the features (or input values) for each of the nodes 616-618 may be randomly generated (e.g., using a computer randomizer). The values generated by the nodes 616 and 618 may be used by the node 622 in the output layer 606 to produce an output value for the artificial neural network 600. When the artificial neural network 600 is used to implement the machine learning module, the output value produced by the artificial neural network 600 may indicate a likelihood of an event (e.g., a prediction with respect to a customer's intent).

The artificial neural network 600 may be trained by using training data. For example, the training data herein may be the NLP analysis done on the textual data of one or more reference users. By providing training data to the artificial neural network 600, the nodes 616-618 in the hidden layer 604 may be trained (adjusted) such that an optimal output (e.g., determining a value for a threshold) is produced in the output layer 606 based on the training data. By continuously providing different sets of training data, and penalizing the artificial neural network 600 when the output of the artificial neural network 600 is incorrect (e.g., when the determined (predicted) likelihood is inconsistent with whether the event actually occurred for the transaction, etc.), the artificial neural network 600 (and specifically, the representations of the nodes in the hidden layer 604) may be trained (adjusted) to improve its performance in data classification. Adjusting the artificial neural network 600 may include adjusting the weights associated with each node in the hidden layer 604.

Although the above discussions pertain to an artificial neural network as an example of machine learning, it is understood that other types of machine learning methods may also be suitable to implement the various aspects of the present disclosure. For example, support vector machines (SVMs) may be used to implement machine learning. SVMs are a set of related supervised learning methods used for classification and regression. A SVM training algorithm—which may be a non-probabilistic binary linear classifier—may build a model that predicts whether a new example falls into one category or another. As another example, Bayesian networks may be used to implement machine learning. A Bayesian network is an acyclic probabilistic graphical model that represents a set of random variables and their conditional independence with a directed acyclic graph (DAG). The Bayesian network could present the probabilistic relationship between one variable and another variable. Other types of machine learning algorithms are not discussed in detail herein for reasons of simplicity.

FIG. 7 illustrates an example cloud-based computing architecture 700, which may also be used to implement various aspects of the present disclosure. The cloud-based computing architecture 700 includes a mobile device 704 (e.g., the user device 110 of FIG. 1) and a computer 702 (e.g., the merchant server 140 or the payment provider server 170), both connected to a computer network 706 (e.g., the Internet or an intranet). In one example, a consumer has the mobile device 704 that is in communication with cloud-based resources 708, which may include one or more computers, such as server computers, with adequate memory resources to handle requests from a variety of users. A given embodiment may divide up the functionality between the mobile device 704 and the cloud-based resources 708 in any appropriate manner. For example, an app on mobile device 704 may perform basic input/output interactions with the user, but a majority of the processing may be performed by the cloud-based resources 708. However, other divisions of responsibility are also possible in various embodiments. In some embodiments, using this cloud architecture, the PEG module 198 may reside on the merchant server 140 or the payment provider server 170, but its functionalities can be accessed or utilized by the mobile device 704, or vice versa.

The cloud-based computing architecture 700 also includes the personal computer 702 in communication with the cloud-based resources 708. In one example, a participating merchant or consumer/user may access information from the cloud-based resources 708 by logging on to a merchant account or a user account at computer 702. The system and method for performing the machine learning as discussed above may be implemented at least in part based on the cloud-based computing architecture 700.

It is understood that the various components of cloud-based computing architecture 700 are shown as examples only. For instance, a given user may access the cloud-based resources 708 by a number of devices, not all of the devices being mobile devices. Similarly, a merchant or another user may access the cloud-based resources 708 from any number of suitable mobile or non-mobile devices. Furthermore, the cloud-based resources 708 may accommodate many merchants and users in various embodiments.

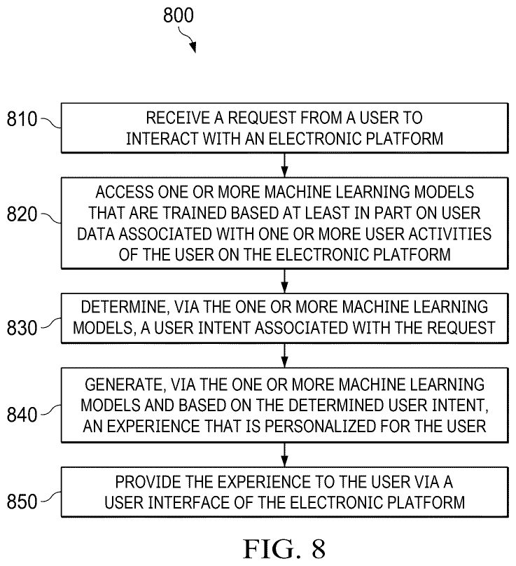

FIG. 8 is a flowchart illustrating a method 800 for generating a personalized experience or content for a user. The various steps of the method 800, which are described in greater detail above, may be performed by one or more electronic processors, for example by the processors of a computer of an entity that may include: a payment provider, a business analyst, or a merchant. The networked system described with respect to FIG. 1 is an example of a system that can perform the method 800. In some embodiments, at least some of the steps of the method 800 may be performed by the PEG module 198, the PEG 250, and/or the system 300 discussed above.

The method 800 includes a step 810 to receive a request from a user to interact with an electronic platform. In some embodiments, the electronic platform may be an entity that operates the payment provider server 170 of FIG. 1. In some other embodiments, the electronic platform may be an entity that operates the merchant server 140 of FIG. 1.

The method 800 includes a step 820 to access one or more machine learning models that are trained based at least in part on user data associated with one or more user activities of the user on the electronic platform. In some embodiments, the one or more user activities occurred via a plurality of user communication channels with the electronic platform, such as the Help Center, the IVR system, or the Automated Assistant (e.g., computer chatbot) of the communication channels 220 of FIG. 2. The request may be received via a first user communication channel (e.g., any one of the Help Center, the IVR system, or the Automated Assistant) of the plurality of user interaction channels.

The method 800 includes a step 830 to determining, via the one or more machine learning models, a user intent associated with the request. For example, the one or more machine learning models may include any one of the machine learning models 310 of FIG. 3, such as the Natural Language Processing (NLP) model 311, the Explainable Artificial Intelligence (XAI) model 312, or the Large Language Model (LLM) 313. In some embodiments, the user intent is determined at least in part via the NLP Intent model 311 and the Customer Data Mat 321 of FIG. 3.

The method 800 includes a step 840 to generate, via the one or more machine learning models and based on the determined user intent, an experience that is personalized for the user. For example, the experience may comprise the Personalized Experience 340A of FIG. 3. The personalized nature of the experience is such that each user may get a different experience than other users, even if the experience is communicated to that user via the same type of communication channel. In some embodiments, the personalized experience is determined at least in part via the XAI model 312 and the Self Service Channel Natures 322 of FIG. 3. For example, the experience is generated at least in part by including a reference to a first user activity (of the one or more user activities), which may be unique to the user. For example, a welcome message displayed by a computer chatbot may greet the user by making a reference to the user's previous activity that occurred via a specific communication channel, such as the fact that the user may have viewed a FAQ page multiple times.

The method 800 includes a step 850 to provide the experience to the user via a user interface of the electronic platform. For example, the experience may comprise a textual message, a voice message, or a list of menu options. In some embodiments, the experience is provided by reconfiguring at least portions of the user interface. In some embodiments, the experience generated in step 840 may be communicated to the user via the user interface 500 of FIGS. 5A-5D or the user interface 550 of FIGS. 5E-5F.

It is understood that additional method steps may be performed before, during, or after the steps 810-850 discussed above. For example, the experience discussed above may be a first experience, and the method 800 may further include the steps of: receiving, from the user, a response to the first experience; generating, via the one or more machine learning models and based on the response, a second experience that is personalized to the user; and providing the second experience to the user via the user interface. For example, the second experience may be the Updated Personalized Experience 340B of FIG. 3. As examples, the second experience may include the textual content shown via the user interface 500 of FIG. 5B or 5D, or as a part of the personalized messages 571-573 of the electronic chat of FIG. 5E. In some embodiments, the one or more machine learning models comprise a Large Language Model (LLM), and the second experience is generated at least in part via the LLM. In some embodiments, the first experience comprises a message pertaining to the determined user intent, and the response comprises a confirmation or a rejection from the user with respect to the determined user intent. Other steps may be performed by the method 800 but are not specifically discussed herein for reasons of simplicity.

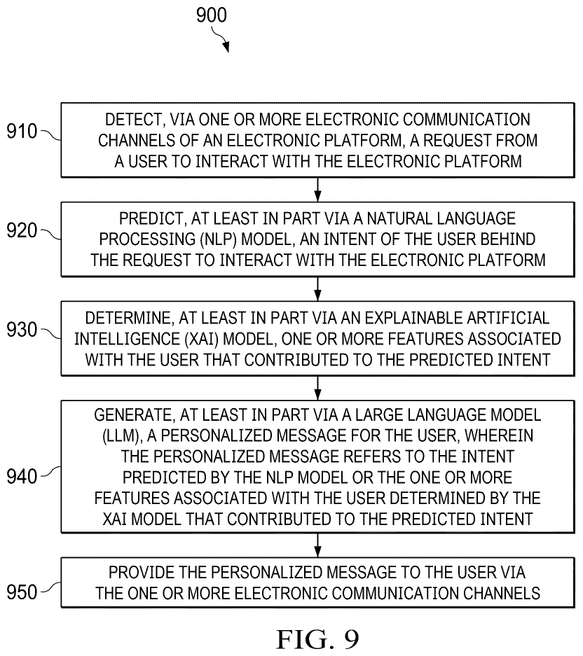

FIG. 9 is a flowchart illustrating a method 900 for generating a personalized message for a user. The various steps of the method 900, which are described in greater detail above, may be performed by one or more electronic processors, for example by the processors of a computer of an entity that may include: a payment provider, a business analyst, or a merchant. The networked system described with respect to FIG. 1 is an example of a system that can perform the method 900. In some embodiments, at least some of the steps of the method 900 may be performed by the PEG module 198, the PEG 250, and/or the system 300 discussed above.

The method 900 includes a step 910 to detect, via one or more electronic communication channels of an electronic platform, a request from a user to interact with the electronic platform. In some embodiments, the one or more electronic communication channels comprise a webpage, an Interactive Voice Response (IVR), a computer chatbot, or an email, which may be example implementations of the entry point 410 of FIG. 4 discussed above. In some embodiments, the step 910 may be performed by the Entry Point 410 and/or the Gateway 420 of FIG. 4.

The method 900 includes a step 920 to predict, at least in part via a Natural Language Processing (NLP) model, an intent of the user behind the request to interact with the electronic platform. In some embodiments, the step 920 may be performed by the Intent Prediction Model 450 of FIG. 4.

The method 900 includes a step 930 to determine, at least in part via an Explainable Artificial Intelligence (XAI) model, one or more features associated with the user that contributed to the predicted intent. In some embodiments, the step 930 may be performed by the XAI Model 460 of FIG. 4.

The method 900 includes a step 940 to generate, at least in part via a Large Language Model (LLM), a personalized message for the user. The personalize message refers to the intent predicted by the NLP model or the one or more features associated with the user determined by the XAI model that contributed to the predicted intent. In some embodiments, the step 940 may be performed by the LLM 480 of FIG. 4.

The method 900 includes a step 950 to provide the personalized message to the user via the one or more electronic communication channels. In some embodiments, the personalized message contains an issue that pertains to the predicted intent and a recommended action for resolving the issue. In some embodiments, the step 950 may be performed by the Entry Point 410 and/or the Gateway 420 of FIG. 4. As examples, the personalized message may be communicated via the user interfaces 500 or 550 discussed above.

It is understood that additional method steps may be performed before, during, or after the steps 910-950 discussed above. For example, the method 900 may include additional steps of: detecting a user action after the personalized message has been provided to the user; updating, at least in part based on the detected user action and at least in part via one or more of the NLP model, the XAI model, or the LLM, the personalized message for the user; and providing the updated personalized message to the user via the one or more electronic communication channels. In some embodiments, the personalized message is provided to the user via a first electronic communication channel of the one or more electronic communication channels; and the updated personalized message is provided to the user via a second electronic communication channel of the one or more electronic communication channels. For example, the first electronic communication channel may be a user interface via a wearable device, and the second electronic communication channel may be a user interface via a desktop/laptop computer screen, a smartphone, or a tablet computer. As another example, the method 900 may include additional steps of: determining, at least in via the XAI model, one or more attribution scores associated with the one or more features, respectively, wherein each of the one or more attribution scores indicates a degree of contribution of the feature associated therewith to the predicted intent; ranking the one or more features based on their respective attribution scores; and identifying a top feature of the one or more features based on the top feature having a highest attribution score. The personalized message refers to the top feature. Other steps may be performed by the method 900 but are not specifically discussed herein for reasons of simplicity.

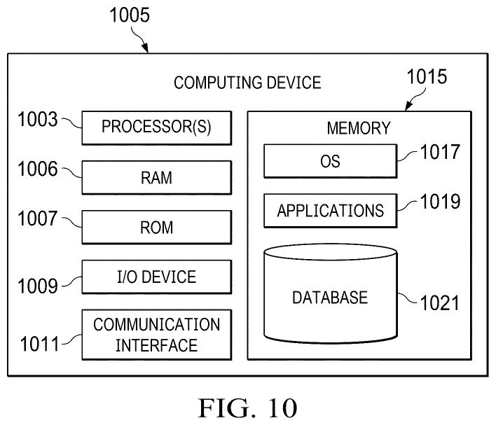

Turning now to FIG. 10, a computing device 1005 that may be used with one or more of the computational systems is described. The computing device 1005 may be used to implement various computing devices discussed above with reference to FIGS. 1-9. For example, the computing device 1005 may be used to implement the PEG module 198 (or portions thereof) of FIG. 1, the PEG module 198 (or portions thereof) of FIG. 2, the system 300 (of portions thereof) of FIG. 3, and/or other components (e.g., the transaction processing application 190) of the payment provider server 170. Furthermore, the computing device 1005 may be used to implement the user device 110, the merchant server 140, the acquirer host 165, the issuer host 168, the PEG module 198, or portions thereof, in various embodiments. The computing device 1005 may include one or more processors 1003 for controlling overall operation of the computing device 1005 and its associated components, including RAM 1006, ROM 1007, input/output device 1009, communication interface 1011, and/or memory 1015. A data bus may interconnect processor(s) 1003, RAM 1006, ROM 1007, memory 1015, I/O device 1009, and/or communication interface 1011. In some embodiments, computing device 1005 may represent, be incorporated in, and/or include various devices such as a desktop computer, a computer server, a mobile device, such as a laptop computer, a tablet computer, a smart phone, any other types of mobile computing devices, and the like, and/or any other type of data processing device.

Input/output (I/O) device 1009 may include a microphone, keypad, touch screen, and/or stylus motion, gesture, through which a user of the computing device 1005 may provide input, and may also include one or more speakers for providing audio output and a video display device for providing textual, audiovisual, and/or graphical output. Software may be stored within memory 1015 to provide instructions to processor(s) 1003 allowing computing device 1005 to perform various actions. For example, memory 1015 may store software used by the computing device 1005, such as an operating system 1017, application programs 1019, and/or an associated internal database 1021. The various hardware memory units in memory 1015 may include volatile and nonvolatile, removable and non-removable media implemented in any method or technology for storage of information such as computer-readable instructions, data structures, program modules, or other data. Memory 1015 may include one or more physical persistent memory devices and/or one or more non-persistent memory devices. Memory 1015 may include, but is not limited to, random access memory (RAM) 1006, read only memory (ROM) 1007, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor(s) 1003.

Communication interface 1011 may include one or more transceivers, digital signal processors, and/or additional circuitry and software for communicating via any network, wired or wireless, using any protocol as described herein.

Processor(s) 1003 may include a single central processing unit (CPU) in some embodiments, which may be a single-core or multi-core processor, or it may include multiple CPUs in other embodiments. In some embodiments, the processor(s) 1003 may include one or more GPUs, in addition to, or in lieu of, the CPUs. The processor(s) 1003 and associated components may allow the computing device 1005 to execute a series of computer-readable instructions to perform some or all of the processes described herein. Although not shown in FIG. 10, various elements within memory 1015 or other components in computing device 1005, may include one or more caches, for example, CPU/GPU caches used by the processor 1003, page caches used by the operating system 1017, disk caches of a hard drive, and/or database caches used to cache content from database 1021. For embodiments including a CPU/GPU cache, the CPU/GPU cache may be used by one or more processors 1003 to reduce memory latency and access time. Processor(s) 1003 may retrieve data from or write data to the CPU/GPU cache rather than reading/writing to memory 1015, which may improve the speed of these operations. In some examples, a database cache may be created in which certain data from a database 1021 is cached in a separate smaller database in a memory separate from the database, such as in RAM 1006 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 1005 are described separately, functionality of the various components may be combined and/or performed by a single component and/or multiple computing devices in communication without departing from the invention.

It should be appreciated that like reference numerals are used to identify like elements illustrated in one or more of the figures, wherein these labeled figures are for purposes of illustrating embodiments of the present disclosure and not for purposes of limiting the same.

One aspect of the present disclosure involves a method. Via one or more electronic communication channels of an electronic platform, a request is detected from a user to interact with the electronic platform. Via a Natural Language Processing (NLP) model, an intent of the user behind the request to interact with the electronic platform is predicted. Via an Explainable Artificial Intelligence (XAI) model, one or more features associated with the user that contributed to the predicted intent are determined. Via a Large Language Model (LLM), a personalized message is generated for the user. The personalize message refers to the intent predicted by the NLP model or the one or more features associated with the user determined by the XAI model that contributed to the predicted intent. The personalized message is provided to the user via the one or more electronic communication channels.

Another aspect of the present disclosure involves a system that includes a non-transitory memory and one or more hardware processors coupled to the non-transitory memory and configured to read instructions from the non-transitory memory to cause the system to perform operations comprising: receiving a request from a user to interact with an electronic platform; accessing one or more machine learning models that are trained based at least in part on user data associated with one or more user activities of the user on the electronic platform; determining, via the one or more machine learning models, a user intent associated with the request; generating, via the one or more machine learning models and based on the determined user intent, an experience that is personalized for the user; and providing the experience to the user via a user interface of a user device of the user, wherein the user interface is associated with the electronic platform.

Yet another aspect of the present disclosure involves a non-transitory machine-readable medium having stored thereon machine-readable instructions executable to cause a machine to perform operations comprising: accessing an interaction between a user and an electronic platform; predicting, based on one or more machine learning models, an intent of the user in association with the interaction, wherein the one or more machine learning models have been trained based at least in part on historical interactions of the user with the electronic platform; generating, based on the predicted intent of the user and via the one or more machine learning models, an experience that is customized to the user; and communicating the experience to the user via one or more communication channels of the electronic platform.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method, comprising:
detecting, via one or more electronic communication channels of an electronic platform, a request from a user to interact with the electronic platform;
predicting, at least in part via a Natural Language Processing (NLP) model, an intent of the user behind the request to interact with the electronic platform;
determining, at least in part via an Explainable Artificial Intelligence (XAI) model, one or more features associated with the user that contributed to the predicted intent;
generating, at least in part via a Large Language Model (LLM), a personalized message for the user, wherein the personalized message refers to the intent predicted by the NLP model or the one or more features associated with the user determined by the XAI model that contributed to the predicted intent; and
providing the personalized message to the user via the one or more electronic communication channels.

2. The method of claim 1, further comprising:
detecting a user action after the personalized message has been provided to the user;
updating, at least in part based on the detected user action and at least in part via one or more of the NLP model, the XAI model, or the LLM, the personalized message for the user; and
providing the updated personalized message to the user via the one or more electronic communication channels.

3. The method of claim 2, wherein:
the personalized message is provided to the user via a first electronic communication channel of the one or more electronic communication channels; and
the updated personalized message is provided to the user via a second electronic communication channel of the one or more electronic communication channels.

4. The method of claim 1, wherein the personalized message contains an issue that pertains to the predicted intent and a recommended action for resolving the issue.

5. The method of claim 1, wherein the one or more electronic communication channels comprise a webpage, an Interactive Voice Response (IVR), a computer chatbot, or an email.

6. The method of claim 1, further comprising:
determining, at least in via the XAI model, one or more attribution scores associated with the one or more features, respectively, wherein each of the one or more attribution scores indicates a degree of contribution of the feature associated therewith to the predicted intent;
ranking the one or more features based on their respective attribution scores; and
identifying a top feature of the one or more features based on the top feature having a highest attribution score, wherein the personalized message refers to the top feature.

7. A system, comprising:
one or more processors; and
a non-transitory computer-readable medium having stored thereon instructions that are executable by the one or more processors to cause a machine to perform operations comprising:
receiving a request from a user to interact with an electronic platform;
accessing one or more machine learning models that are trained based at least in part on user data associated with one or more user activities of the user on the electronic platform;
determining, via the one or more machine learning models, a user intent associated with the request;
generating, via the one or more machine learning models and based on the determined user intent, an experience that is personalized for the user; and
providing the experience to the user via a user interface of a user device of the user, wherein the user interface is associated with the electronic platform.

8. The system of claim 7, wherein the experience is generated at least in part by including a reference to a first user activity of the one or more user activities.

9. The system of claim 7, wherein:
the one or more machine learning models comprise a Natural Language Processing (NLP) model and an Explainable Artificial Intelligence (XAI) model;
the user intent is determined at least in part via the NLP model; and
the experience is determined at least in part via the XAI model.

10. The system of claim 7, wherein the experience is a first experience, and wherein the operations further comprises:
receiving, from the user, a response to the first experience;
generating, via the one or more machine learning models and based on the response, a second experience that is personalized to the user; and
providing the second experience to the user via the user interface.

11. The system of claim 10, wherein:
the one or more machine learning models comprise a Large Language Model (LLM); and
the first experience or the second experience is generated at least in part via the LLM.

12. The system of claim 10, wherein:
the first experience comprises a message pertaining to the determined user intent; and
the response comprises a confirmation or a rejection from the user with respect to the determined user intent.

13. The system of claim 7, wherein the experience comprises a textual message, a voice message, or a list of menu options.

14. The system of claim 7, wherein the experience is provided at least in part by reconfiguring at least one portion of the user interface.

15. A non-transitory machine-readable medium having stored thereon machine-readable instructions executable to cause performance of operations comprising:
accessing an interaction between a user and an electronic platform;
predicting, based on one or more machine learning models, an intent of the user in association with the interaction, wherein the one or more machine learning models have been trained based at least in part on historical interactions of the user with the electronic platform;
generating, based on the predicted intent of the user and via the one or more machine learning models, an experience that is customized to the user; and
communicating the experience to the user via one or more communication channels of the electronic platform.

16. The non-transitory machine-readable medium of claim 15, wherein:
the interaction between the user and the electronic platform is conducted via a first communication channel of the one or more communication channels; and
the first communication channel comprises a webpage, an Interactive Voice Response (IVR) system, or an electronic chat.

17. The non-transitory machine-readable medium of claim 15, wherein the experience is communicated at least in part by prompting the user to confirm whether the predicted intent is accurate.

18. The non-transitory machine-readable medium of claim 15, wherein the experience contains a reference to one or more of the historical interactions of the user with the electronic platform.

19. The non-transitory machine-readable medium of claim 15, wherein:
the intent of the user is predicted at least in part via a Natural Language Processing (NLP) model of the one or more machine learning models; and
the experience is generated at least in part via an Explainable Artificial Intelligence (XAI) model or a Large Language Model (LLM) of the one or more machine learning models.

20. The non-transitory machine-readable medium of claim 15, wherein the operations further comprise:
detecting a user action in response to the experience that has been communicated to the user;
updating, based on the detected user action and via the one or more machine learning models, the experience that is customized to the user; and
communicating, to the user, the updated experience via the one or more communication channels of the electronic platform.
